(19) United States
(12) Patent Application Publication
(10) Pub. No.: US 2019/0098220 A1
(43) Pub. Date: Mar. 28, 2019

(54) Tracking A Moving Target Using Wireless Signals

(71) Applicant: WiSpear Systems Ltd., Limassol (CY)

(72) Inventor: Oz Liv, Ramat Hasharon (IL)

(21) Appl. No.: 15/715,938

(22) Filed: Sep. 26, 2017

(51) Int. Cl. H04N 5/232; G01S 5/02; G01S 13/46

(52) U.S. Cl. CPC H04N 5/23296; H04N 7/18; G01S 13/46; G01S 5/0263

(57) ABSTRACT

A system and method are provided for visually tracking a moving (e.g., walking) target using wireless technology. Wireless access points detect transmissions from wireless mobile devices and extract identifying information from such devices. If a device is identified as belonging to a target of interest, antenna array or arrays are used to continually determine bearing of device relative to each antenna array, and to determine triangulated position of device if possible. Bearings and/or position so determined are used to aim camera or cameras and thus track and capture images of target of interest.

### TECHNICAL FIELD

The present application relates generally to visual surveillance systems, and particularly, to systems for identifying a moving target of interest and visually tracking the target using cameras.

### BACKGROUND

Camera-based surveillance systems are in use in many locations to which the public has access, such as retail stores and shopping centers, airports and train stations, public parks and streets, schools, sports and entertainment venues, and many others. Such cameras are used, among other things, to aid in the investigation of crimes and other incidents after-the-fact. In general, surveillance/security cameras operate passively, by capturing whatever they “see” with their lenses from their fixed positions, and recording the images or transmitting them to be viewed and/or recorded at fixed time intervals. Some surveillance cameras are equipped with motors in their mounting that enable the camera to be moved so as to point in different directions from its mounting point, thus enabling the capture of a wider visual field as the camera is pivoted. During passive operation, movable cameras may be regularly moved, or “swept,” in a fixed, repeated pattern, in order to capture surveillance images over a broader angle.

Surveillance camera systems, when used passively, gather images that can be used for purposes of investigation after-the-fact, but are not useful for responding to incidents as they occur. In order to do so, a surveillance camera system needs to be actively monitored, and in some cases controlled, by a human operator, who can see what is happening in view of the cameras, and can direct the cameras appropriately: to point a camera at a target of interest, to activate certain cameras, to zoom in on a target, etc. However, it can be costly to employ human operators to monitor security cameras, and the effectiveness of a system in responding to an incident and tracking a target will depend on the alertness, reaction time and skill of the operator.

Many persons carry with them wireless mobile devices, such as cell phones, tablets, monitoring bracelets, and so on, that allow such devices to be uniquely identified and located by a wireless network. See, e.g., [“Methods and Systems for Estimating Location of a Wireless Client Device,” U.S. Pat. No. 9,500,737 (2016)]. What is needed is a system that uses such technology to identify and track a target of interest, and to use location information regarding that target to control cameras in order to provide effective visual surveillance of the target.

### SUMMARY

Aspects of the disclosure are directed to a system comprising a processor, a wireless receiver, a camera, and a camera control unit, for tracking a moving target of interest, comprising a wireless access point comprising an antenna assembly that receives a wireless radio frequency (RF) transmission from a mobile transmitter of a mobile device, said wireless access point configured and arranged to extract identifying information from a RF signal in said RF transmission, and further configured and arranged to determine a position of said mobile device; a data store containing information regarding a plurality of mobile devices of interest; and a processor in data communication with said wireless access point and said data store, configured and arranged to take an input from the wireless access point representing the position of the mobile device, to query the data store, and to compare said identifying information to an identifier of interest stored in said data store; the processor further configured and arranged, when a positive comparison between said identifying information and the identifier of interest is made, to generate an output control signal that controls a camera control unit to direct a camera towards the position of the mobile device.

Other aspects are directed to a method for visually tracking a moving target of interest, comprising intercepting, in a first wireless access point, a first transmission made by a first wireless mobile device; extracting, from said first transmission intercepted, a first identifier associated with the first wireless mobile wireless device; associating the first identifier with a recorded identifier stored in a database of identifiers-of-interest; using a first antenna array in the first wireless access point to determine at least a bearing of the first wireless mobile device relative to the first wireless access point; and using at least said bearing determined, pointing a camera in a direction of the first wireless mobile device, thereby gaining access to first visual data of the moving target of interest associated with the first wireless mobile device.

### IN THE DRAWINGS

For a fuller understanding of the nature and advantages of the present invention, reference is made to the following detailed description of preferred embodiments and in connection with the accompanying drawings, in which:

FIG. 1 is a schematic diagram illustrating the system and method disclosed herein, according to an embodiment;

FIG. 2 is a schematic diagram illustrating the system and method disclosed herein, according to another embodiment;

FIG. 3 is a flowchart illustrating the operating of the system and method disclosed herein, according to an embodiment; and

FIG. 4 is a flowchart illustrating the system and method disclosed herein, according to another embodiment.

### DETAILED DESCRIPTION

The system and method disclosed herein use wireless technology to identify a person of interest by the wireless device carried by such person, and to control a camera or cameras so as to track such person and capture images of him or her, including while such person walks or otherwise moves about. A person of interest could be a criminal suspect, someone under investigation, a person on a “watch list,” a missing or runaway child, an older person with senile dementia, and so forth. Because of the ubiquity and widespread use of smart phones and other wireless devices, it will often be possible to uniquely identify and track a person using a wireless device associated with such person. In some cases, a wireless device carried by a person involuntarily, such as a monitoring bracelet, can be used to track a person.

The system and method uses a wireless access point, e.g. a Wi-Fi access point, and antenna array with wireless access to a location that are covered by one or more cameras, which are mounted and equipped with motors so that the direction to which they point can be controlled remotely by microprocessor commands. The system works in connection with a stored database of identifiers of wireless devices, such as media access control (MAC) addresses or international mobile equipment identity (IMEI) numbers, associated with persons of interest. Such a database, which would be regularly updated, may be based on alerts received from law enforcement and other authorities and security personnel and/or other sources. The wireless access point regularly receives transmissions from wireless mobile devices in its range, and extracts their unique identifiers, comparing these identifiers to the identifiers-of-interest in the database to determine where there is a match.

If there is a match, then the system is activated. The antenna array is used to obtain a bearing of the wireless mobile device of interest, and any cameras that are in range of this location are commanded to point in the direction of the target device. As the location changes, as long as the device is in range of the wireless access point, the wireless access point continues to receive transmissions from the now-identified mobile device of interest, and each time it receives a transmission the antenna array continues to re-compute the location of the device, and the camera or cameras are commanded to point in the direction of the target as that direction changes, as long as the device remains within camera range. As a target moves into the range of a camera, that camera will be activated to track the target. In some embodiments the system issues an alert when a device of interest is identified, allowing human operators to monitor the situation in real time, and possibly to take action, e.g. to apprehend the person of interest.

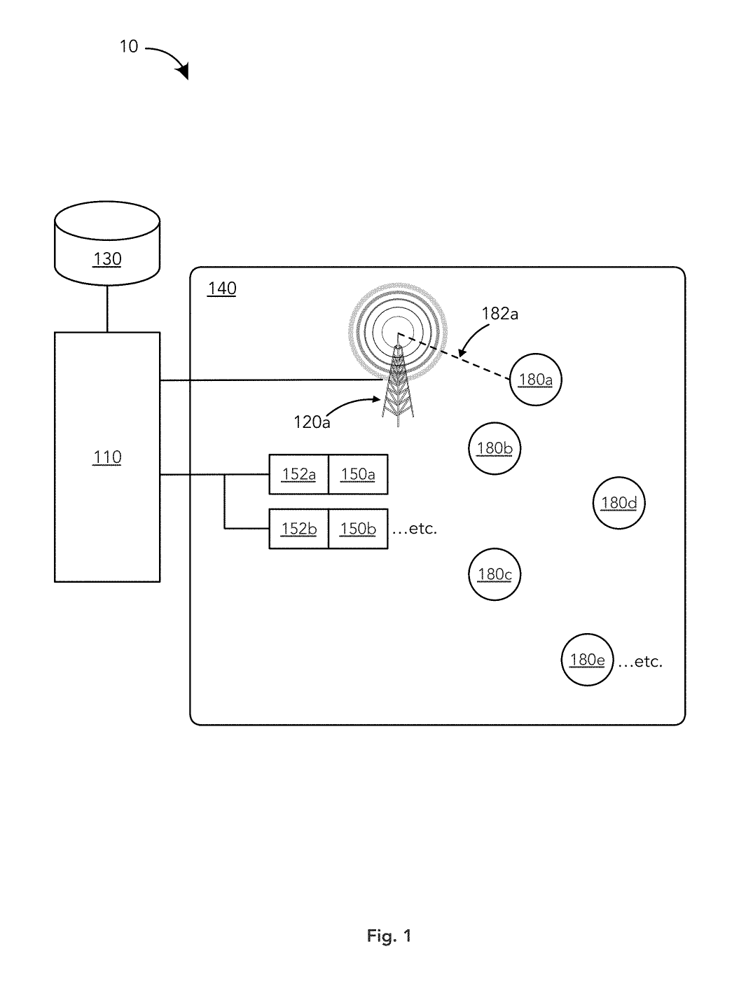

FIG. 1 illustrates an embodiment of a system 10, which includes processor 110, which includes receive circuitry and working memory, and which is in communication with antenna array 120a and database 130, which may be a remote connection over the internet or otherwise. Antenna array 120a continually receives signals from wireless mobile devices 180a, 180b, etc. within area 140, which is within range of the antenna array, and sends such signals to receive circuitry within processor 110, which extracts, from such signals, identifiers, such as MAC addresses or IMEI numbers, associated with such wireless devices. Database 130 contains a list of identifiers of devices-of-interest; such list may include devices of particular interest to a specific location (e.g. a retail store), or a more general area such a city or county, or nationwide. Processor 110 compares each identifier extracted from a wireless mobile device or mobile RF transmitter within area 140 with the list of identifiers in a data store or database 130 to determine if there is a match. The data store is equipped with a plurality of data storage locations containing information about a plurality of mobile transmitting devices that could include information about a device-of-interest (e.g., a mobile phone of a person-of-interest). If a match is found between the identifier of the detected device and a device-of-interest, indicating that a device-of-interest is located within area 140, then the relevant identifier is stored by processor 110 in working memory as an identifier of a detected device-of-interest.

The system then proceeds to determine the location of the wireless device-of-interest by determining a bearing 182a of device-of-interest 180a relative to antenna array 120a. The system may further determine an absolute or a relative position or bearing of a device-of-interest (generally “position”). Processor 110, including receive circuitry therein, utilize techniques, such as beamforming techniques, to determine the direction from which signals transmitted from wireless device-of-interest 180a are received by antenna array 120a. Such techniques may include: (i) using a phased array of several antennas to determine a phase difference between the different antennas, in which said phase difference is indicative of the direction from which signals transmitted from wireless device-of-interest 180a are received by the phased array, (ii) using several antenna arrays to capture a spatial signature of the target transmission, in which each spatial signature is unique to a respective locations, and therefore enables determination of the location of interest and therefore also the related direction, and (iii) using a beamforming network, such as a Butler matrix or a Rotman lens, to determine a direction of arrival of the signal of interest. Other techniques are also possible, or a combination of the techniques could be utilized. Some techniques permit an antenna or antenna array to have increased antenna gain in a preferential direction relative to other directions, and to change such preferential direction electronically, i.e. without mechanically moving any components, based on instructions received from a processor. Such techniques may utilize a phased antenna array and/or a switched directional antenna mechanism to sweep through different possible angles from which a signal from wireless device-of-interest is received, to determine the angle with the strongest signal, and thus to determine a bearing 182a of such device relative to the antenna array. Once such bearing is determined, processor 110 transmits commands to motors 152a, 152b, etc. on which cameras 150a, 150b, etc. are mounted, to move such cameras to point in the direction of the bearing so determined.

The antenna array 120a continues to receive signals from wireless device-of-interest 180a as long as such device is within range of the antenna array. As such signals are received, the processor, along with the receive circuitry and the antenna array, continue to re-compute the bearing 182a of the device-of-interest relative to the antenna array 120a, and to transmit commands to the motors 152x to re-orient the cameras 150x to point in the direction of the bearing so determined.

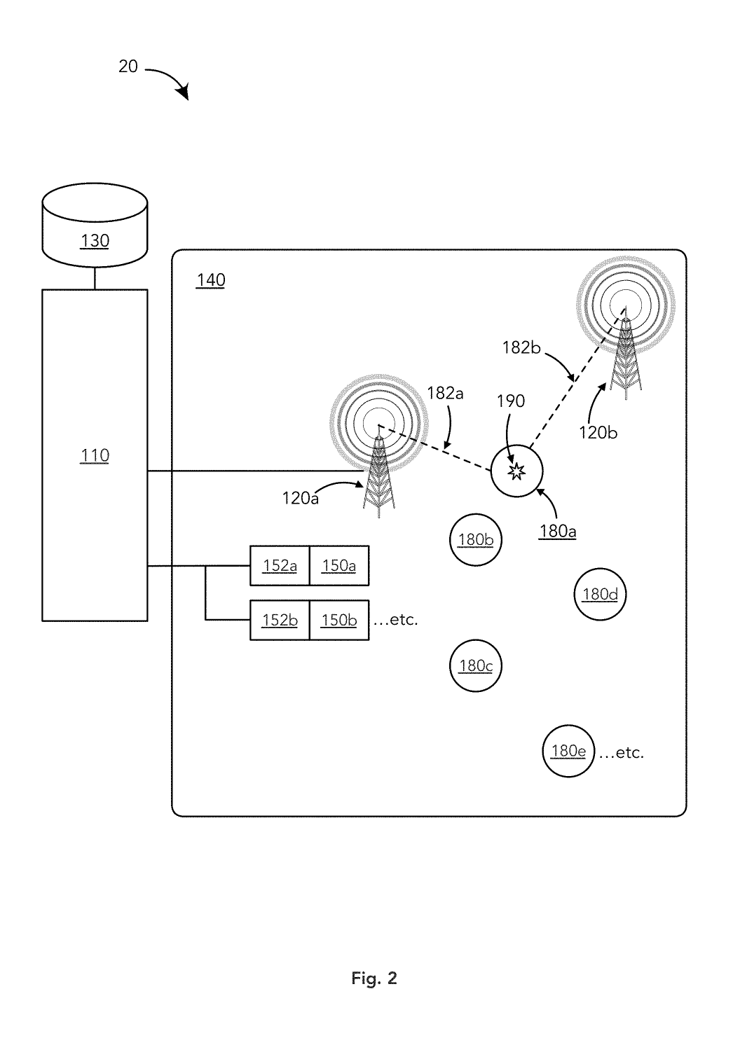

FIG. 2 illustrates another embodiment of a system 20, comprising a plurality of antenna arrays 120a, 120b, etc. at different locations from one another, all within range of signals transmitted by wireless mobile devices within area 140. Two such antenna arrays are depicted on the figure, but any number of such antenna arrays 120x are possible. Each antenna array is connected to processor 110 including receive circuitry thereof, and processor 110 is connected to database 130 as in FIG. 1. Each antenna array 120a, 120b, etc. continually receives signals from wireless mobile devices 180a, 180b, etc. within area 140, which is within range of the antenna array, and sends such signals to receive circuitry within processor 110, which extracts, from such signals, identifiers, such as MAC addresses or IMEI numbers, associated with such wireless devices. As in FIG. 1, processor 110 compares each identifier extracted from a wireless mobile device within area 140 with the list of identifiers in database 130 to determine if there is a match. If a match is found, indicating that a device-of-interest is located within area 140, then the relevant identifier is stored by processor 110 in working memory as an identifier of a detected device-of-interest.

The system then proceeds to determine the location of the wireless device-of-interest by determining a bearing 182a of device-of-interest 180a relative to antenna array 120b, and a bearing 182b of device-of-interest 180a relative to antenna array 120b, as in FIG. 1. Once such bearings are determined, processor 110 uses the bearings to triangulate the position of the device of interest 180a by determining the point 190 at which the bearings intersect. Processor 110 then transmits commands to motors 152a, 152b, etc. on which cameras 150a, 150b, etc. are mounted, to move such cameras to point in the direction of the triangulated position so determined.

The antenna arrays 120a, 120b, etc. continue to receive signals from wireless device-of-interest 180a as long as such device is within range of the antenna array. As such signals are received, the processor, along with the receive circuitry and the antenna array, continue to re-compute the bearing 182 of the device-of-interest relative to each antenna array 120 which is receiving signals from the device, to re-triangulate the position of the device using such bearings, and to transmit commands to the motors 152 to re-orient the cameras 150 to point in the direction of the position so determined.

Those skilled in the art will appreciate that the shown configurations are illustrative and exemplary and that numerous other configurations are possible without departing from the scope of the present disclosure. Also, the present disclosure is directed to radiation and transmission/reception in three dimensions as well as in two dimensions without loss of generality. The configurations shown are in schematic form and are not drawn to scale.

In some embodiments the system uses facial detection or other image processing technology to identify a person associated with a target device, and to improve the tracking and image capture of the person of interest. Such techniques may be used in conjunction with analysis of data regarding the locations of the transmitting mobile device of interest and visual data captured from such locations, and may be used to enhance images obtained from cameras by identifying the image of the target person-of-interest in such a way as to distinguish his/her image from the images of other persons contained in the visual data captured by the camera or cameras.

In a preferred embodiment, the system utilizes a plurality of wireless access points, each with an antenna array, with overlapping coverage regions. If a target wireless device is detected within the region of overlapping coverage, then two or more antenna arrays may be used to determine a bearing of the target device, and the position of the device can be more precisely determined using triangulation techniques. Information regarding the device's position can then be used to more accurately position one or more cameras, which may include focusing and/or zooming in such cameras, and can be used to better identify the target person in the images captured by the camera or cameras.

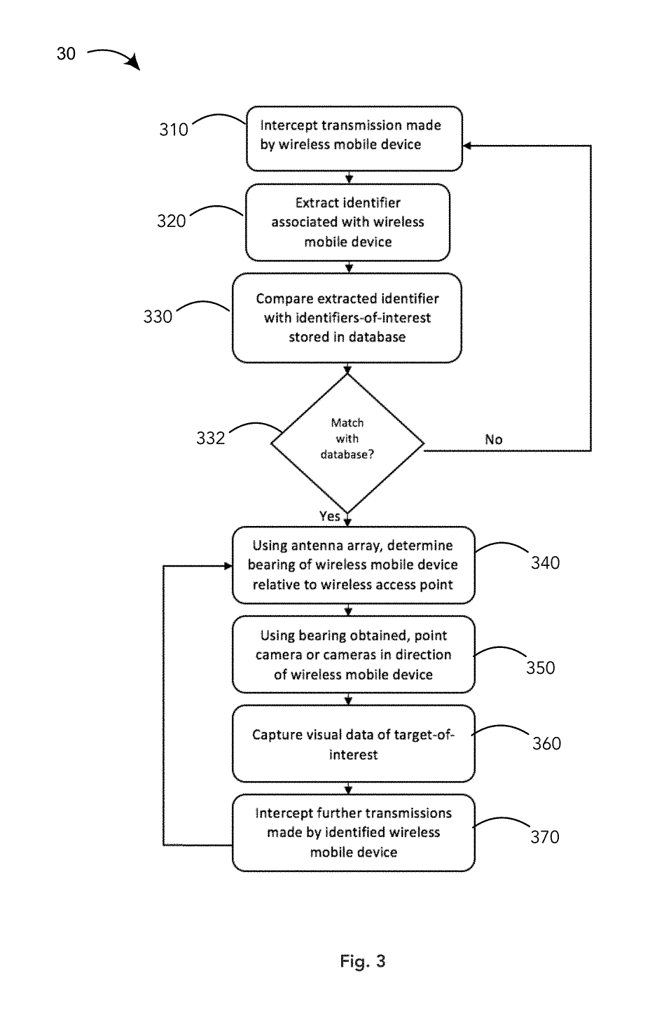

The operation of the system, according to an embodiment, is illustrated in the flowchart 30 in FIG. 3. At step 310 an antenna array intercepts a transmission made by a wireless mobile device within its range. At step 320 an identifier associated with the device is extracted from the transmission, and at step 330 the extracted identifier is compared with the list of identifiers-of-interest stored in the database. If there is not a match, then step 332 returns the procedure to step 310, where further transmissions from other wireless mobile devices in range are intercepted. If there is a match, then at step 340 a bearing of the device-of-interest relative to the antenna array is determined, and at step 350 the system points a camera or cameras in the direction of the bearing so determined. At step 360 the camera or cameras capture visual data of the target-of-interest. At step 370 the antenna array continues to intercept transmissions made by the identified device of interest, and then the process repeats from step 340, wherein the bearing is continually recomputed and the camera or cameras re-oriented in order to continue to capture visual data regarding the target-of-interest.

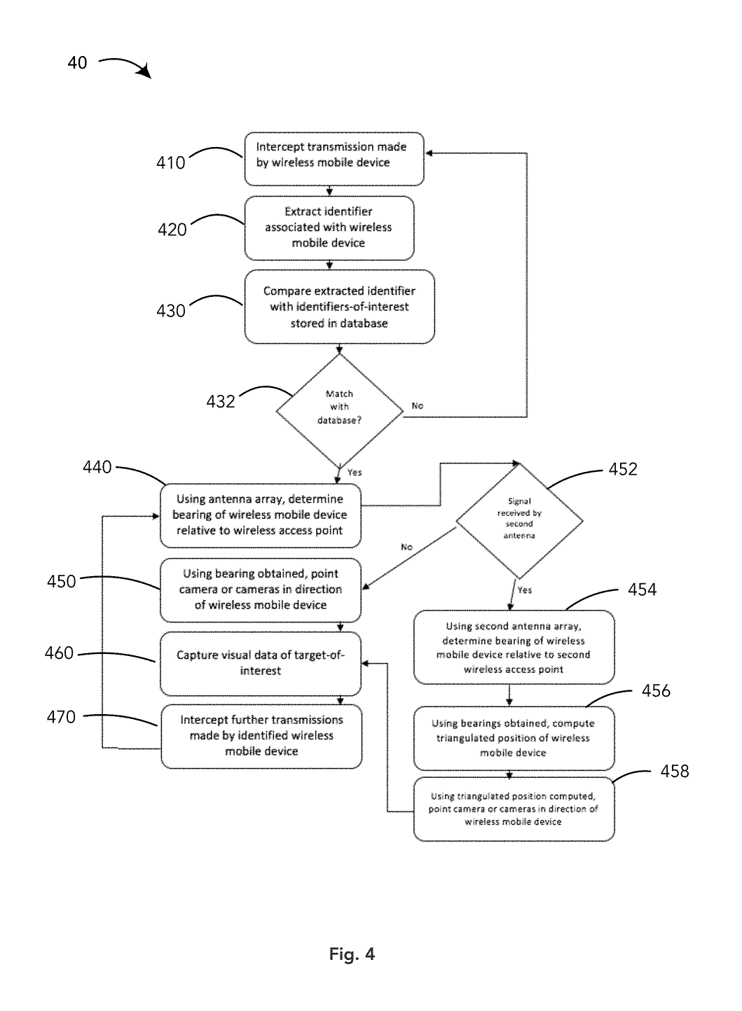

FIG. 4 depicts a flowchart 40 illustrating the operation of the system according to another embodiment, which includes a plurality of antenna arrays. Many steps in such flowchart are similar to like-numbered steps in flowchart 30 in FIG. 3. After step 440, at which a bearing has been determined for a wireless device-of-interest relative to a first antenna array, at step 452 it is determined whether a signal from such device is being received by a second antenna array. If not, then the system proceeds with step 450, but if so, then at step 454 the second antenna array is used to compute a bearing of the device-of-interest relative to such antenna array. Subsequently, at step 456 the two bearings obtained relative to the two antenna arrays are used to compute a triangulated position of the device, and at step 458 the triangulated position so computed is used to point the cameras in the direction of the device. The procedure then moves to step 460, where visual data of the target is captured, and so forth as in flowchart 30 in FIG. 3.

It is to be appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. Variations and modifications of the embodiments described herein, which would occur to persons skilled in the art upon reading the foregoing description, are contemplated by and included in this disclosure.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein. The present materials, methods, and examples are illustrative only and not intended to be limiting.

What is claimed is:

1. A method for visually tracking a moving target of interest, comprising:
intercepting, in a first wireless access point, a first transmission made by a first wireless mobile device;
extracting, from said first transmission intercepted, a first identifier associated with the first wireless mobile wireless device;
associating the first identifier with a recorded identifier stored in a database of identifiers-of-interest;
using a first antenna array in the first wireless access point to determine at least a bearing of the first wireless mobile device relative to the first wireless access point; and
using at least said bearing determined, pointing a camera in a direction of the first wireless mobile device, thereby gaining access to first visual data of the moving target of interest associated with the first wireless mobile device.

2. The method of claim 1, wherein the first identifier is a media access control (MAC) address of the first wireless mobile device.

3. The method of claim 1 wherein the first transmission is a Wi-Fi transmission, and the first wireless access point is a Wi-Fi access point.

4. The method of claim 1, wherein said determination of a bearing is done using a beamforming technique associated with the first antenna array.

5. The method of claim 4, wherein said first antenna array is a phased array.

6. The method of claim 4, wherein said first antenna array is switched directional antenna mechanism.

7. The method of claim 1, wherein said determination of a bearing comprises a triangulation of a position in which the wireless mobile device is located, and said triangulation is achieved in conjunction with a second antenna array in a second wireless access point.

8. The method of claim 1, further comprising:
intercepting, again, in the first wireless access point or a second wireless access point, a second transmission made by the first wireless mobile device;
extracting, from said second transmission intercepted, the first identifier;
using the first antenna array, or a second antenna array, to determine at least a second bearing of the first wireless mobile device relative to the first wireless access point or relative to the second wireless access point; and
using at least said second bearing determined, pointing the camera, or another camera, in a second direction of the first wireless mobile device, thereby gaining access to second visual data of the moving target of interest.

9. The method of claim 8, wherein the first visual data is taken in conjunction with a first location of the moving target of interest, and the second visual data is taken in conjunction with a second location of the moving target of interest.

10. The method of claim 9, wherein the first visual data contains mixed representations of both the moving target of interest and other moving entities, and the second visual data contains mixed representations of both the moving target of interest and other moving entities, the method further comprising:
comparing the first visual data and the second visual data; and
isolating the moving target of interest as the one appearing in both the first visual data and the second visual data.

11. The method of claim 9, further comprising:
constructing a visual record of a path traversed by the moving target of interest using at least both the first visual data and the second visual data.

12. A system comprising a processor, a wireless receiver, a camera, and a camera control unit, for tracking a moving target of interest, comprising:
a wireless access point comprising an antenna assembly that receives a wireless radio frequency (RF) transmission from a mobile transmitter of a mobile device, said wireless access point configured and arranged to extract identifying information from a RF signal in said RF transmission, and further configured and arranged to determine a position of said mobile device;
a data store containing information regarding a plurality of mobile devices of interest; and
a processor in data communication with said wireless access point and said data store, configured and arranged to take an input from the wireless access point representing the position of the mobile device, to query the data store, and to compare said identifying information to an identifier of interest stored in said data store;
the processor further configured and arranged, when a positive comparison between said identifying information and the identifier of interest is made, to generate an output control signal that controls a camera control unit to direct a camera towards the position of the mobile device.

13. The system of claim 12, said antenna assembly comprising a plurality of receiver units that act as an antenna array and collectively directionally determine a bearing or range to the mobile transmitter.

14. The system of claim 12, said antenna assembly comprising a directional geometric antenna having directional sensitivity to determine a bearing or range to the mobile transmitter.

15. The system of claim 12, wherein the position of the mobile device comprises geographic coordinates thereof.

16. The system of claim 12, wherein the position of the mobile device comprises a bearing to the mobile device.
